(19) United States
(12) Patent Application Publication
(10) Pub. No.: US 2026/0108847 A1
(43) Pub. Date: Apr. 23, 2026

(54) RECYCLING SYSTEM UTILIZING HIGHLY EFFICIENT COMBUSTION OF WASTE GAS CIRCULATION

(71) Applicant: Sacurn Carbon CO., LTD., New Taipei (TW)

(72) Inventors: KUO-MING HUANG, New Taipei (TW); CHIA-YU LAI, New Taipei (TW)

(21) Appl. No.: 19/360,769

(22) Filed: Oct. 16, 2025

(30) Foreign Application Priority Data
Oct. 17, 2024 (TW) 113139560

(51) Int. Cl. B01D 53/75

(52) U.S. Cl. CPC B01D 53/75; B01D 2258/05

(57) ABSTRACT

A recycling system utilizing highly efficient combustion of waste gas circulation comprises a carbonization device, a first collecting pipeline, a first detection and control unit, an air guide device, a heating unit, and a purification device. The carbonization device contains a biomass to be burned to generate a biogas. The first detection and control unit detects a content proportion of a combustible gas of the biogas and controls its flow direction. The air guide device is used to convey the combustible gas into the carbonization device. An oxygen and pressure sensing module in the heating unit controls a content proportion of the introduced combustible gas and re-combusts and utilizes the combustible gas, and a remaining non-combustible gas enters the purification device for a purification process. A diameter of a first gas outlet is larger than a diameter of a first gas inlet of the first collecting pipeline.

### BACKGROUND OF THE INVENTION

### Field of Invention

The invention relates to a recycling system utilizing highly efficient combustion of waste gas circulation, more particularly to a recycling system utilizing highly efficient combustion of waste gas circulation capable of highly efficiently using combustible waste gas.

### Related Art

Biomass broadly refers to organic matter produced by living organisms, including wood, agricultural crops and their waste, and biological excrement. Biomass commonly used for energy combustion includes wood chips, soybeans, corn, rice husks, and marsh gas. Because biomass is formed by the conversion of CO2 through photosynthesis, it consumes atmospheric CO2. The CO2 emitted by biomass as a fuel is recycled back into the atmosphere. Compared to burning fossil fuels originally buried in the stratum, its entire life cycle does not increase atmospheric CO2. Therefore, replacing fossil fuels with biomass helps mitigate global warming and is considered one of the alternative energy sources on the path to net-zero carbon emissions.

However, the use of low-carbon energy sources is still not enough to slow the trend of global temperature rise. Further development of carbon negative technology is needed to continuously reduce global CO2 concentration, which is a more positive direction of energy technology development.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively address the aforementioned issues, a primary object of the invention is to provide a recycling system utilizing highly efficient combustion of waste gas circulation capable of highly efficiently using combustible waste gas.

A secondary object of the invention is to provide a recycling system utilizing highly efficient combustion of waste gas circulation capable of significantly reducing pollution from waste gas emissions.

Yet another secondary object of the invention is to provide a recycling system utilizing highly efficient combustion of waste gas circulation capable of significantly reducing an energy consumption of carbonization systems.

In order to achieve the above-mentioned objects, the invention provides a recycling system utilizing highly efficient combustion of waste gas circulation, which comprises a carbonization device, a first collecting pipeline, a first detection and control unit, an air guide device, a heating unit and a purification device. The carbonization device contains a biomass to be burned inside to generate a biogas, the carbonization device has a first gas outlet, the biogas is exhausted from the first gas outlet, one end of the first collecting pipeline is communicated with the first gas outlet of the carbonization device, another end of the first collecting pipeline is provided with a first gas inlet, so that the biogas enters the first collecting pipeline from the first gas outlet and passes through the first gas inlet, the first detection and control unit is electrically connected to the carbonization device, which is used to detect a content proportion of a combustible gas of the biogas and control a flow direction of the combustible gas, the air guide device is connected to the first gas inlet and is used to convey the combustible gas into the carbonization device, the heating unit has an oxygen and pressure sensing module electrically connected to the air guide device, the oxygen and pressure sensing module is used to control a content proportion of the combustible gas introduced into the air guide device, and re-combust and utilize the combustible gas, the purification device is electrically connected to the first detection and control unit, when the first detection and control unit detects that a content proportion of the combustible gas of the biogas exhausted from the carbonization device is lower than a content required by environmental protection regulations, a remaining non-combustible gas enters the purification device for a purification process, wherein the first gas outlet has a first diameter, the first gas inlet has a second diameter, the first diameter is larger than the second diameter so that the biogas forms a fluid continuity equation and Bernoulli's law during a flow process.

In one embodiment, further comprising a pressurizing device connected to the air guide device, the pressurizing device being used to provide a pressure to assist the biogas in the first collecting pipeline to flow forward.

In one embodiment, the pressurizing device is composed of a plurality of blades, the blades have at least one bearing for driving the blades to rotate.

In one embodiment, the pressurizing device comprises an active pressurizer and a passive pressurizer.

In one embodiment, the passive pressurizer is operated by an exhaust pressure of the biogas, while the active pressurizer is driven by a motor to operate.

In one embodiment, further comprising a second collecting pipeline connected to a second gas outlet of the heating unit, a second detection and control unit electrically connected to the heating unit, the second detection and control unit being used to detect whether the biogas exhausted from the heating unit containing a combustible gas, if a combustible gas being detected, the combustible gas being controlled to flow through the second collecting pipeline toward the first collecting pipeline and then re-enter the heating unit for combustion and utilization.

In one embodiment, the purification device is further electrically connected to the second detection and control unit, if the second detection and control unit detects that a content proportion of the combustible gas of the biogas exhausted from the heating unit is lower than a content required by environmental protection regulations, a remaining non-combustible gas enters the purification device for a purification process.

In one embodiment, the second gas outlet of the heating unit is further provided with an exhaust control valve, the exhaust control valve is connected to the oxygen and pressure sensing module, when an internal pressure of the heating unit is too high, the oxygen and pressure sensing module controls the exhaust control valve to open and release the internal pressure.

In one embodiment, further comprising a heat-to-electricity device connected to the air guide device, after the oxygen and pressure sensing module determining a content of the combustible gas required in the heating unit, the combustible gas being introduced to the heating unit via the air guide device, and the excessive combustible gas being introduced to the heat-to-electricity device through the air guide device for recycling.

In one embodiment, the biomass in the carbonization device is burned to produce a biochar, and a particle size of the biochar is between 1 mm and 20 mm.

With a design of the recycling system of the invention, when the carbonization device burns the biomass therein, the biogas is generated. The biogas is then exhausted from the first gas outlet and enters the first collecting pipe. At the same time, the first detection and control unit detects a content proportion of the combustible gas of the biogas, and with a diameter of the first gas outlet larger than a diameter of the first gas inlet, the biogas forms a fluid continuity equation and Bernoulli's law during a flow process. A pressure provided by the pressurizing device is then used to assist the biogas in the first collecting pipe to flow toward the air guide device. Finally, the oxygen and pressure sensing module of the heating unit is used to control a proportion of a combustible gas introduced into the air guide device via the pressurizing device. On the other hand, when the first detection and control unit detects that a content proportion of the combustible gas of the biogas exhausted from the carbonization device is lower than a content required by environmental protection regulations, a remaining non-combustible gas enters the purification device for a purification process.

In other words, the oxygen and pressure sensing module detects a temperature inside the heating unit and calculates an oxygen content required inside the heating unit, thereby controlling a proportion of a combustible gas introduced from the pressurizing device to the air guide device. Thereby, an efficacy of the combustible gas capable of being re-burned and utilized can be achieved for efficient recycling of combustible waste gas.

### BRIEF DESCRIPTION OF THE DRAWINGS

FIG. 1 is a structural schematic diagram of a first embodiment of a recycling system of the invention.

FIG. 2 is a block diagram of the first embodiment of the recycling system of the invention.

FIG. 3 is a structural schematic diagram of a second embodiment of the recycling system of the invention.

FIG. 4 is a structural schematic diagram of a third embodiment of the recycling system of the invention;

FIG. 5 is a structural schematic diagram of a fourth embodiment of the recycling system of the invention.

FIG. 6 is a block diagram of the fourth embodiment of the recycling system of the invention.

FIG. 7 is a structural schematic diagram of a fifth embodiment of the recycling system of the invention.

FIG. 8 is a structural schematic diagram of a sixth embodiment of the recycling system of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to a recycling system utilizing highly efficient combustion of waste gas circulation of the invention, various applicable examples are exemplified and explained in detail with reference to the accompanying drawings; however, the invention is of course not limited to the enumerated embodiments, drawings, or detailed descriptions.

Furthermore, those who are familiar with The technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numbers.

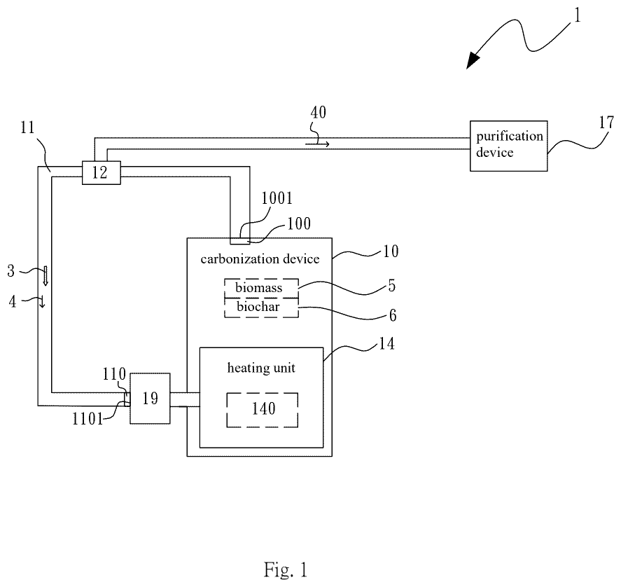

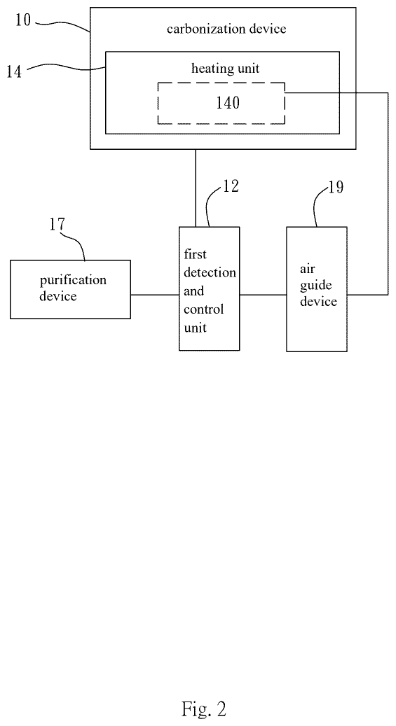

Please refer to FIGS. 1 and 2 for a structural schematic diagram and a block diagram of a first embodiment of a recycling system utilizing highly efficient combustion of waste gas circulation of the invention respectively. As shown in the figures, a recycling system 1 utilizing highly efficient combustion of waste gas circulation comprises a carbonization device 10, a first collecting pipeline 11, a first detection and control unit 12, an air guide device 19, a heating unit 14 and a purification device 17. The carbonization device 10 contains a biomass 5 to be carbonized to generate a biogas 3. The carbonization device 10 has a first gas outlet 100, and the biogas 3 is exhausted from the first gas outlet 100. Wherein it should be noted that after the biomass 5 inside the carbonization device 10 is carbonized, a biochar 6 is generated. A particle size of the biochar 6 is between 1 mm and 20 mm. A particle size of the biochar 6 is limited in order to control an overall carbonization temperature, combustion rate, carbonization quality, and uniformity inside the recycling system 1.

One end of the first collecting pipe 11 is communicated with the first gas outlet 100 of the carbonization device 10, and another end of the first collecting pipe 11 is provided with a first gas inlet 110. This configuration enables the biogas 3 to enter the first collecting pipe 11 from the first gas outlet 100 and pass through the first gas inlet 110.

It should be noted that the first gas outlet 100 has a first diameter 1001, while the first gas inlet 110 has a second diameter 1101. The first diameter 1001 is larger than the second diameter 1101. This design ensures that the biogas 3 forms a fluid continuity equation and Bernoulli's law during a flow process, thereby effectively accelerating a flow of the biogas 3 in the first collecting pipe 11.

The first detection and control unit 12 is electrically connected to the carbonization device 10. The first detection and control unit 12 is used to detect a content proportion of a combustible gas 4 of the biogas 3 and control a flow direction of the combustible gas 4.

The air guide device 19 is connected to the first gas inlet 110. The air guide device 19 is used to convey the combustible gas 4 into the carbonization device 10. The air guide device 19 is capable of adjusting the biogas 3 to optimize an air-fuel ratio.

The heating unit 14 comprises an oxygen and pressure sensing module 140 electrically connected to the air guide device 19. The oxygen and pressure sensing module 140 controls a proportion of the combustible gas 4 introduced into the air guide device 19, enabling the combustible gas 4 to be recombusted and utilized. The oxygen and pressure sensing module 140 further has an efficacy of calculating gas flow rate and volume.

In addition, the recycling system 1 further comprises a purification device 17 electrically connected to the first detection and control unit 12. If the first detection and control unit 12 detects that a content proportion of the combustible gas 4 of the biogas 3 exhausted from the carbonization device 10 is lower than a content required by environmental protection regulations, indicating that the combustible gas 4 in the first collecting pipeline 11 has been completely combusted, the first detection and control unit 12 controls a remaining non-combustible gas 40 to flow into the purification device 17 for a purification process.

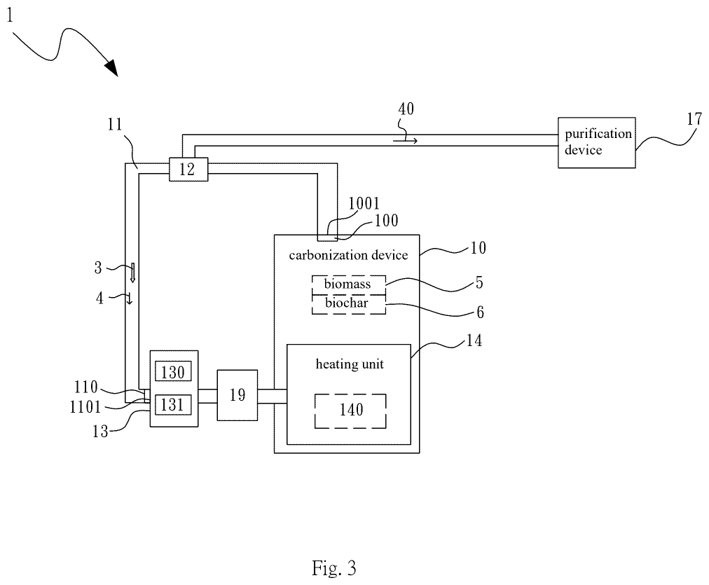

Please refer to FIG. 3 for a structural schematic diagram of a second embodiment of the recycling system of the invention. The recycling system 1 further comprises a pressurizing device 13 disposed between the first collecting pipe 11 and the air guide device 19. A function of the pressurizing device 13 is to provide a pressure to assist the biogas 3 in the first collecting pipe 11 to flow forward. It should be noted that, in this embodiment, the pressurizing device 13 is composed of a plurality of blades (not shown in the figure), the blades have at least one smooth bearing for driving the blades to rotate. Furthermore, the pressurizing device 13 further comprises an active pressurizer 130 and a passive pressurizer 131. A pressure of the pressurizing device 13 is provided by the active pressurizer 130 being driven by a motor to generate operational rotation. For example, the active pressurizer 130 can be a mechanical pressurizer or another equivalent device. Alternatively, the passive pressurizer 131 can be operated by an exhaust pressure from the biogas 3. For example, the passive pressurizer 131 can be a turbocharger or another equivalent device.

Therefore, through a design of the recycling system 1 of the invention, when the carbonization device 10 burns the biomass 5 therein, the biogas 3 is generated. The biogas 3 is then exhausted from the first gas outlet 100 and enters the first collecting pipe 11. At the same time, the first detection and control unit 12 detects a content proportion of the combustible gas 4 of the biogas 3, and with a structural design of a diameter of the first gas outlet 100 larger than a diameter of the first gas inlet 110, the biogas 3 forms a fluid continuity equation and Bernoulli's law during a flow process. A pressure provided by the pressurizing device 13 is then used to assist the biogas 3 in the first collecting pipe 11 to flow toward the air guide device 19. Finally, the oxygen and pressure sensing module 140 of the heating unit 14 is used to control a proportion of the combustible gas 4 introduced into the air guide device 19 via the pressurizing device 13. On the other hand, when the first detection and control unit 12 detects that a content proportion of the combustible gas 4 of the biogas 3 exhausted from the carbonization device 10 is lower than a content required by environmental protection regulations, the remaining non-combustible gas 40 enters the purification device 17 for a purification process.

In other words, the oxygen and pressure sensing module 140 detects a temperature inside the heating unit 14 and calculates an oxygen content required inside the heating unit 14, thereby controlling a proportion of the combustible gas 4 introduced from the pressurizing device 13 to the air guide device 19. Thereby, an efficacy of the combustible gas 4 capable of being re-burned and utilized can be achieved for efficient recycling of combustible waste gas, significantly reducing an energy consumption of the recycling system 1, and at the same time significantly reducing greenhouse gas emissions.

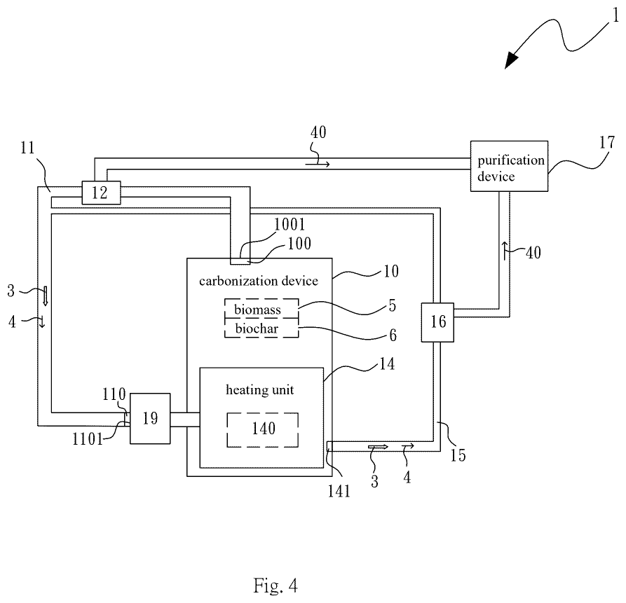

Please refer to FIG. 4 for a structural schematic diagram of a third embodiment of the recycling system of the invention. Corresponding relationships between some components of the recycling system utilizing highly efficient combustion of waste gas circulation are the same as those of the aforementioned recycling system utilizing highly efficient combustion of waste gas circulation, so they will not be repeated here. However, main differences between the recycling system utilizing highly efficient combustion of waste gas circulation and the aforementioned recycling system utilizing highly efficient combustion of waste gas circulation are that the recycling system 1 further has a second collecting pipeline 15, the second collecting pipeline 15 is connected to a second gas outlet 141 of the heating unit 14, and a second detection and control unit 16 is electrically connected to the heating unit 14. The second detection and control unit 16 is used to detect whether the biogas 3 exhausted from the heating unit 14 contains the combustible gas 4. If the combustible gas 4 is detected, the combustible gas 4 is controlled to flow back to the first collecting pipeline 11 through the second collecting pipeline 15 and then re-enter the heating unit 14 for a third combustion and utilization.

Furthermore, the purification device 17 is electrically connected to the second detection and control unit 16. If the second detection and control unit 16 detects that a content proportion of the combustible gas 4 of the biogas 3 exhausted from the heating unit 14 is lower than a content required by environmental protection regulations, indicating that the combustible gas 4 in the second collecting pipeline 15 has been completely combusted, the second detection and control unit 16 controls the remaining non-combustible gas 40 to flow into the purification device 17 for a purification process.

In addition, it should be noted that the second detection and control unit 16, the purification device 17, and the air guide device 19 are respectively provided with a pressure relief valve (not shown in the figure). The pressure relief valve has a function of regulating an internal pressure to avoid abnormal pressure or overload in the carbonization device 10.

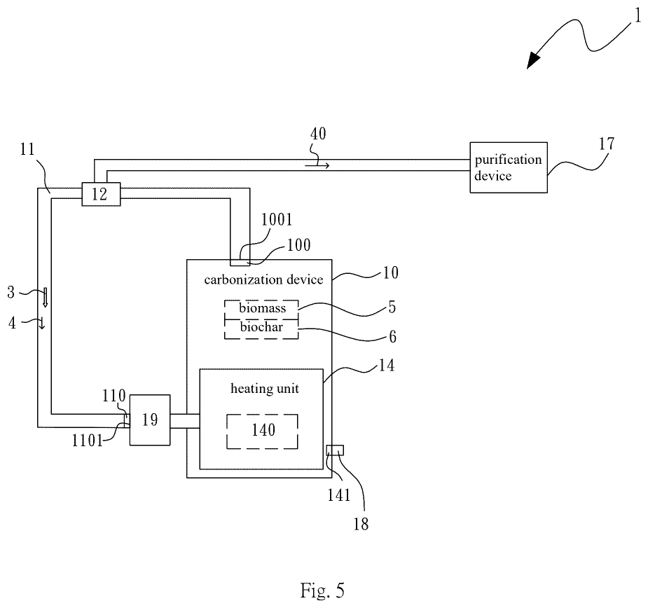

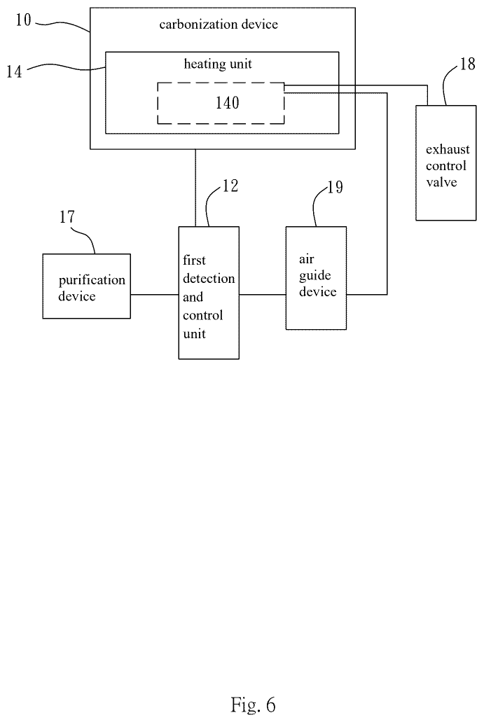

Please refer to FIGS. 5 and 6 for a structural schematic diagram and a block diagram of a fourth embodiment of the recycling system of the invention respectively. Corresponding relationships between some components of the recycling system utilizing highly efficient combustion of waste gas circulation are the same as those of the aforementioned recycling system utilizing highly efficient combustion of waste gas circulation, so they will not be repeated here. However, main differences between the recycling system utilizing highly efficient combustion of waste gas circulation and the aforementioned recycling system utilizing highly efficient combustion of waste gas circulation are that an exhaust control valve 18 is further provided at the second gas outlet 141 of the heating unit 14. The exhaust control valve 18 is electrically connected to the oxygen and pressure sensing module 140. When an internal pressure in the heating unit 14 is too high, the oxygen and pressure sensing module 140 controls the exhaust control valve 18 to open and release the internal pressure of the heating unit 14. In other words, the exhaust control valve 18 is used to adjust and control an amount of gas in the heating unit 14.

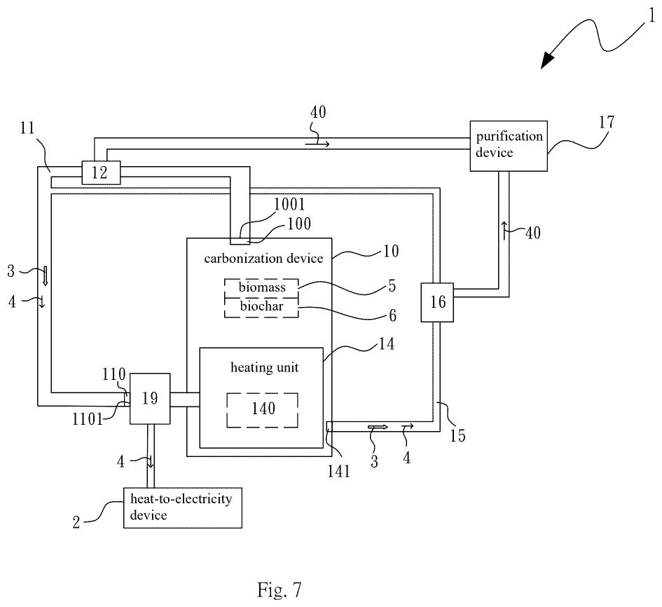

Please refer to FIG. 7 for a structural schematic diagram of a fifth embodiment of the recycling system of the invention. Corresponding relationships between some components of the recycling system utilizing highly efficient combustion of waste gas circulation are the same as those of the aforementioned recycling system utilizing highly efficient combustion of waste gas circulation, so they will not be repeated here. However, main differences between the recycling system utilizing highly efficient combustion of waste gas circulation and the aforementioned recycling system utilizing highly efficient combustion of waste gas circulation are that the recycling system 1 further comprises a heat-to-electricity device 2 connected to the first collecting pipeline 11 and the air guide device 19. After the oxygen and pressure sensing module 140 determines a content of the combustible gas 4 required in the heating unit 14, the combustible gas 4 is introduced into the heating unit 14 through the air guide device 19, and the excessive combustible gas 4 can be further introduced into the heat-to-electricity device 2 through the air guide device 19 for recycling, thereby achieving efficient utilization of combustible waste gas.

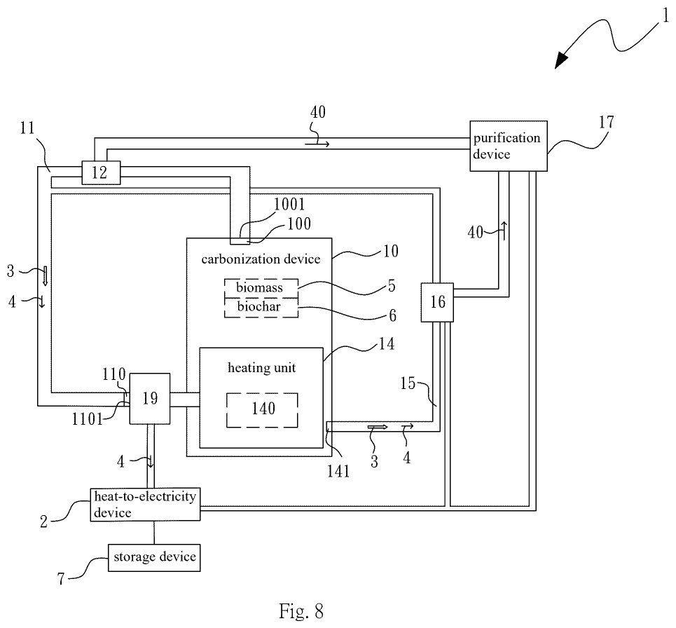

Finally, please refer to FIG. 8 for a structural schematic diagram of a sixth embodiment of the recycling system of the invention. Corresponding relationships between some components of the recycling system utilizing highly efficient combustion of waste gas circulation are the same as those of the aforementioned recycling system utilizing highly efficient combustion of waste gas circulation, so they will not be repeated here. However, main differences between the recycling system utilizing highly efficient combustion of waste gas circulation and the aforementioned recycling system utilizing highly efficient combustion of waste gas circulation are that the second detection and control unit 16 and the purification device 17 are respectively connected to the heat-to-electricity device 2 to collect the excess combustible gas 4 for recycling. Furthermore, the heat-to-electricity device 2 is further connected to a storage device 7. This design of the recycling system 1 enables the storage device 7 to store excess thermal energy for later conversion to electrical energy when needed, thereby achieving efficient utilization of combustible waste gas.

In summary, the invention has the following advantages compared to the prior art:
1. efficient utilization of combustible waste gas;
2. significantly reducing pollution from waste gas emissions; and
3. significantly reducing an energy consumption of carbonization systems.

It is to be understood that the above description is provided for the preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. A recycling system utilizing highly efficient combustion of waste gas circulation, comprising:
a carbonization device containing a biomass to be burned inside to generate a biogas, the carbonization device having a first gas outlet, the biogas being exhausted from the first gas outlet;
a first collecting pipeline, one end of the first collecting pipeline being communicated with the first gas outlet of the carbonization device, another end of the first collecting pipeline being provided with a first gas inlet, so that the biogas entering the first collecting pipeline from the first gas outlet and passing through the first gas inlet;
a first detection and control unit electrically connected to the carbonization device, the first detection and control unit being used to detect a content proportion of a combustible gas of the biogas and control a flow direction of the combustible gas;
an air guide device connected to the first gas inlet, the air guide device being used to convey the combustible gas into the carbonization device;
a heating unit having an oxygen and pressure sensing module electrically connected to the air guide device, the oxygen and pressure sensing module being used to control a content proportion of the combustible gas introduced into the air guide device, and re-combust and utilize the combustible gas; and
a purification device electrically connected to the first detection and control unit, when the first detection and control unit detecting that a content proportion of the combustible gas of the biogas exhausted from the carbonization device being lower than a content required by environmental protection regulations, a remaining non-combustible gas entering the purification device for a purification process;
wherein the first gas outlet has a first diameter, the first gas inlet has a second diameter, the first diameter is larger than the second diameter so that the biogas forms a fluid continuity equation and Bernoulli's law during a flow process.

2. The recycling system utilizing highly efficient combustion of waste gas circulation as claimed in claim 1, further comprising a pressurizing device connected to the air guide device, the pressurizing device being used to provide a pressure to assist the biogas in the first collecting pipeline to flow forward.

3. The recycling system utilizing highly efficient combustion of waste gas circulation as claimed in claim 2, wherein the pressurizing device is composed of a plurality of blades, the blades have at least one bearing for driving the blades to rotate.

4. The recycling system utilizing highly efficient combustion of waste gas circulation as claimed in claim 2, wherein the pressurizing device comprises an active pressurizer and a passive pressurizer.

5. The recycling system utilizing highly efficient combustion of waste gas circulation as claimed in claim 4, wherein the passive pressurizer is operated by an exhaust pressure of the biogas.

6. The recycling system utilizing highly efficient combustion of waste gas circulation as claimed in claim 4, wherein the active pressurizer is driven by a motor to operate.

7. The recycling system utilizing highly efficient combustion of waste gas circulation as claimed in claim 1, further comprising a second collecting pipeline connected to a second gas outlet of the heating unit, a second detection and control unit electrically connected to the heating unit, the second detection and control unit being used to detect whether the biogas exhausted from the heating unit containing a combustible gas, if a combustible gas being detected, the combustible gas being controlled to flow through the second collecting pipeline toward the first collecting pipeline and then re-enter the heating unit for combustion and utilization.

8. The recycling system utilizing highly efficient combustion of waste gas circulation as claimed in claim 6, wherein the purification device is further electrically connected to the second detection and control unit, if the second detection and control unit detects that a content proportion of the combustible gas of the biogas exhausted from the heating unit is lower than a content required by environmental protection regulations, a remaining non-combustible gas enters the purification device for a purification process.

9. The recycling system utilizing highly efficient combustion of waste gas circulation as claimed in claim 6, wherein the second gas outlet of the heating unit is further provided with an exhaust control valve, the exhaust control valve is connected to the oxygen and pressure sensing module, when an internal pressure of the heating unit is too high, the oxygen and pressure sensing module controls the exhaust control valve to open and release the internal pressure.

10. The recycling system utilizing highly efficient combustion of waste gas circulation as claimed in claim 1, further comprising a heat-to-electricity device connected to the air guide device, after the oxygen and pressure sensing module determining a content of the combustible gas required in the heating unit, the combustible gas being introduced to the heating unit via the air guide device, and the excessive combustible gas being introduced to the heat-to-electricity device through the air guide device for recycling.

11. The recycling system utilizing highly efficient combustion of waste gas circulation as claimed in claim 1, wherein the biomass in the carbonization device is burned to produce a biochar, and a particle size of the biochar is between 1 mm and 20 mm.
